(19) United States
(12) Patent Application Publication
(10) Pub. No.: US 2016/0252226 A1
(43) Pub. Date: Sep. 1, 2016

(54) VEHICLE LAMP

(71) Applicant: T.Y.C. BROTHER INDUSTRIAL CO., LTD., Tainan City (TW)

(72) Inventors: Ming-Chin SHIH, Tainan City (TW); Ming-Hsien TSAI, Tainan City (TW)

(21) Appl. No.: 14/935,063

(22) Filed: Nov. 6, 2015

(30) Foreign Application Priority Data
Feb. 26, 2015 (TW) 104203024

(51) Int. Cl. F21S 8/10

(52) U.S. Cl. CPC F21S 48/1241; F21S 48/2281; F21S 48/21; F21S 48/328

(57) ABSTRACT

A vehicle lamp includes two light guide plates, and at least one light emitting module. Each light guide plate has two side surfaces opposite to each other in a thickness direction, and a light input surface and a light output surface interconnecting the side surfaces. A length in the thickness direction between the side surfaces of each of the light guide plates is not greater than 10 millimeters. One of the side surfaces of one of the light guide plates faces one of the side surfaces of the other one of the light guide plates, such that the light input surfaces of the light guide plates are adjacent to each other. Each light emitting module is disposed at a position corresponding to the light input surface of a corresponding light guide plate.

### CROSS-REFERENCE TO RELATED APPLICATION

This application claims priority of Taiwanese Patent Application Number 104203024, filed on Feb. 26, 2015, the disclosure of which is incorporated herein by reference.

### FIELD

The disclosure relates to a lamp, more particularly to a vehicle lamp.

### BACKGROUND

A conventional vehicle lamp typically includes a light emitting member that generates light, and a light guide lens that focuses and guides the light from the light emitting member toward a desired direction.

Depending on different designers and purposes, different vehicle lamps are created for projecting light of various shapes. These different shapes of projected light generally result from changes to the shape of the light guide lens. Therefore, varying the shape of the projected light requires creation of different molds for shaping different light guide lenses, so that the manufacturing cost of the conventional vehicle lamp is relatively high.

Moreover, it is generally difficult to manufacture a light guide lens that possesses a thickness greater than 10 millimeters. Such difficulty limits the variation of the size of the light guide lens.

### SUMMARY

Therefore, the object of the disclosure is to provide a vehicle lamp that is easy to manufacture and that has a relatively low manufacturing cost.

Accordingly, a vehicle lamp includes two light guide plates, and at least one light emitting module. Each of the light guide plates has two side surfaces that are opposite to each other in a thickness direction, and a light input surface arid a light output surface that interconnect the side surfaces. A length in the thickness direction between the side surfaces of each of the light guide plates is not greater than 10 millimeters. One of the side surf aces of one of the light guide plates faces one of the side surfaces of the other one of the light guide plates, such that the light input surfaces of the light guide plates are adjacent to each other. The at least one light emitting module includes a circuit board that faces the light input surfaces of the light guide plates and that has a length in the thickness direction not smaller than a total length of the light guide plates in the thickness direction, and two light emitting members that are mounted on the circuit board. Each of the light emitting members is disposed at a position corresponding to the light input surface of a corresponding one of the light guide plates. The at least one light emitting module further includes a heat sink that is connected to the circuit board.

### BRIEF DESCRIPTION OF THE DRAWINGS

Other features and advantages of the disclosure will become apparent in the following detailed description of the embodiments with reference to the accompanying drawings, of which:

FIG. 1 is an exploded perspective view of a first embodiment of a vehicle lamp according to the disclosure;

FIG. 2 is a fragmentary partly exploded perspective view of the first embodiment;

FIG. 3 is a top view of the first embodiment;

FIG. 4 is a fragmentary front sectional view of the first embodiment;

FIG. 5 is a side sectional view of the first embodiment;

FIG. 6 is a top view of a second embodiment of the vehicle lamp according to the disclosure;

FIG. 7 is a perspective view illustrating an arrangement of two light guide plates of a third, embodiment of the vehicle lamp according to the disclosure; and

FIG. 8 is a side sectional view of a fourth embodiment of the vehicle lamp according to the disclosure.

### DETAILED DESCRIPTION OF THE PREFERRED EMBODIMENTS

Before the present invention is described in greater detail with reference to the accompanying embodiments, it should be noted herein that like elements are denoted by the same reference numerals throughout the disclosure.

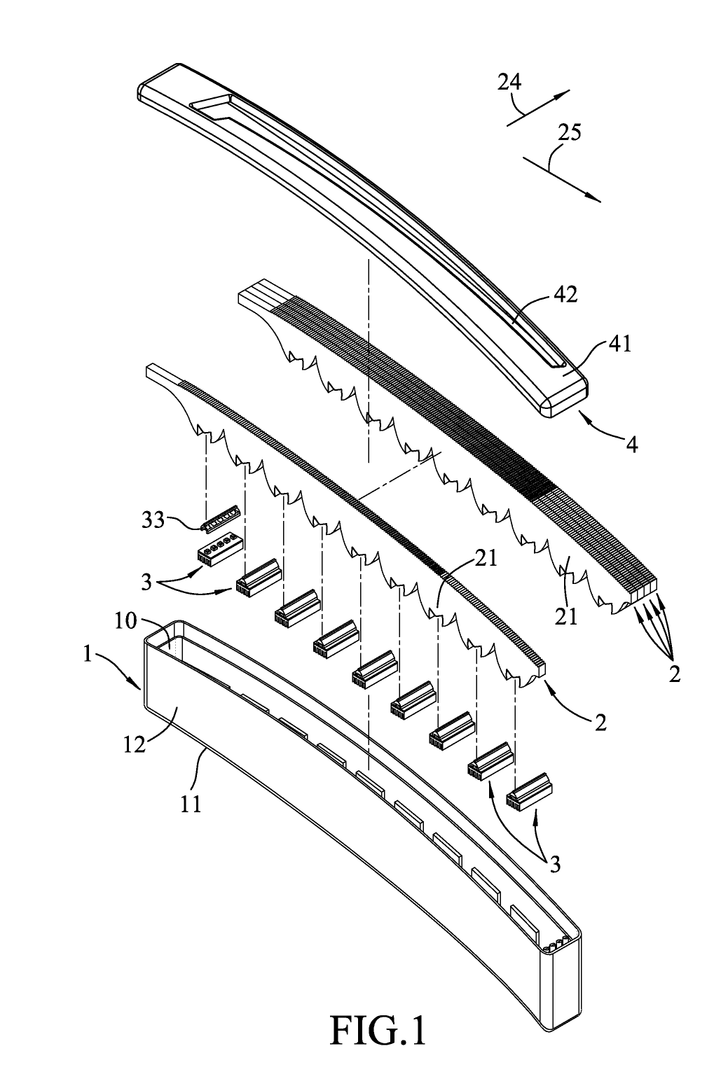

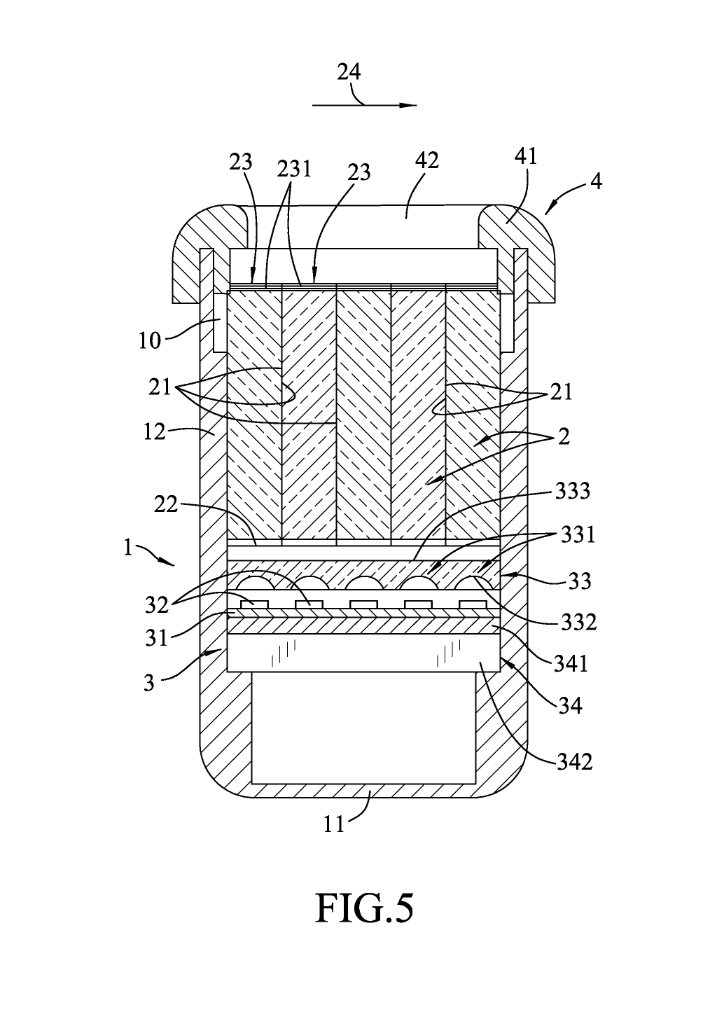

Referring to FIG. 1 to 5, a first embodiment of a vehicle lamp according to the disclosure is illustrated, which includes five light guide plates 2, a plurality of light emitting modules 3, a housing 1 that retains the light guide plates 2 and the light emitting module 3 therein, and a cover member 4 that is coupled to the housing 1 and that covers a portion of the light guide plates 2.

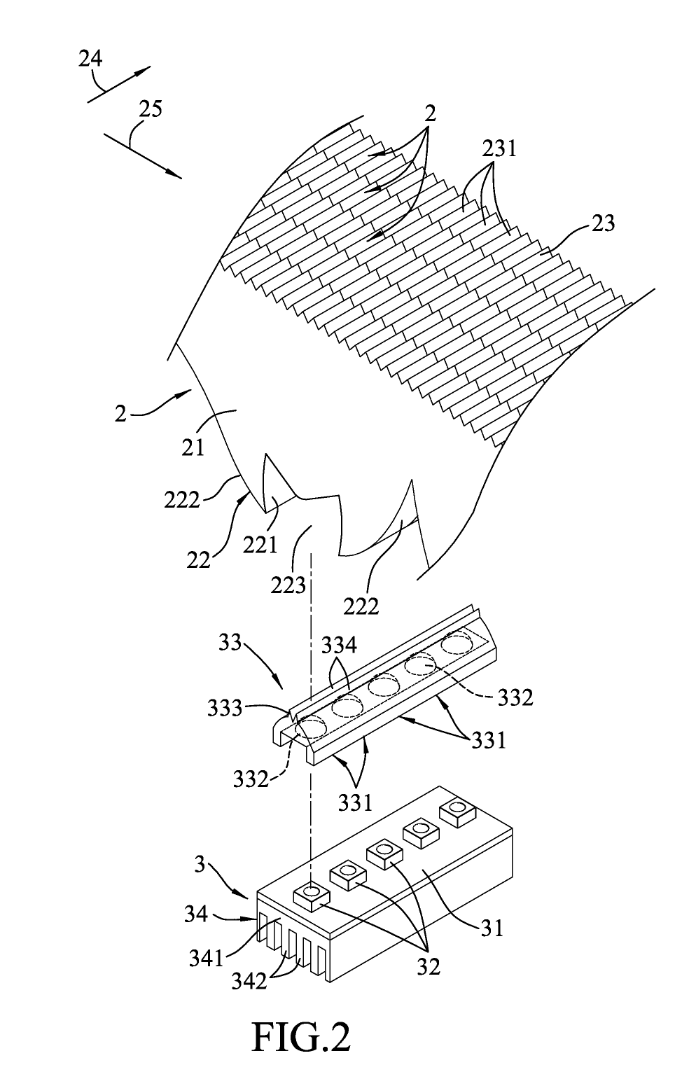

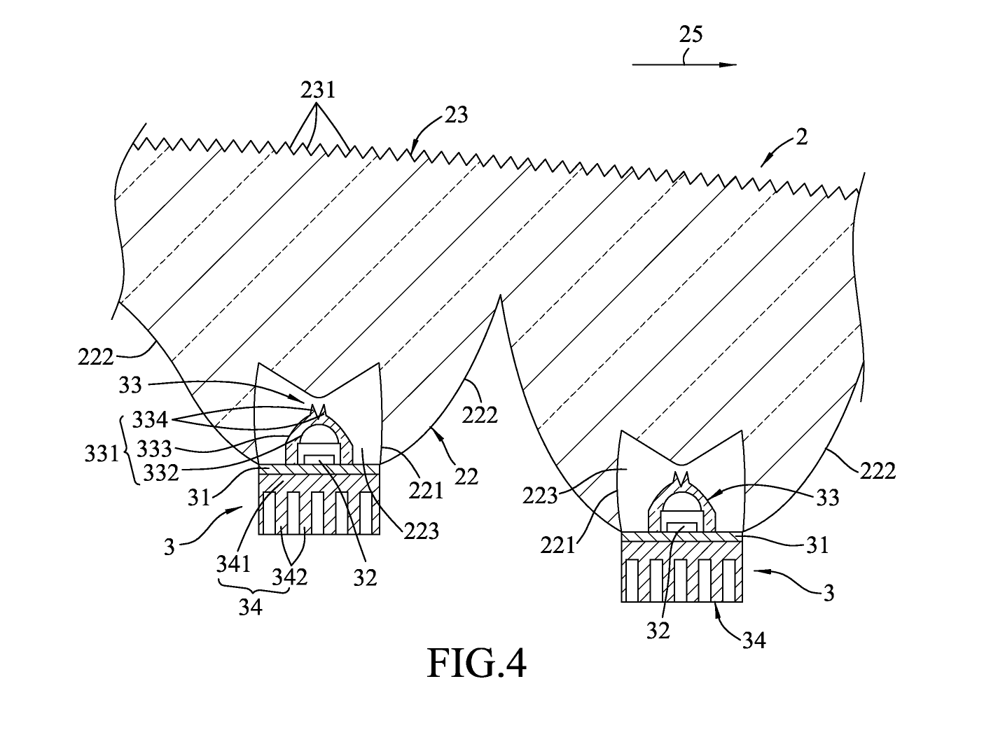

As shown in FIGS. 2 and 4, the light guide plates 2 are made of transparent plastic materials. Each of the light guide plates 2 has two side surfaces 21 that are opposite to each other in a thickness direction 24, and a light input surface 22 and a light output surface 23 that interconnect the side surfaces 21. In this embodiment, the light input surface 22 and the light output surface 23 are spaced apart from each other.

As shown in FIG. 4, the light input surface 22 of each of the light guide plates 2 has a plurality of input surface portions 221 arranged in a longitudinal direction 25 that is transverse to the thickness direction 24, and a plurality of connecting surface portions 222 respectively interconnecting each two adjacent ones of the input surface portions 221 (i.e., the input surface portions 221 and the connecting surface portions 222 are alternately arranged). Furthermore, each of the input surface portions 221 is formed with a recess 223. Each of the connecting surface portions 222 is formed as an indentation clearly dividing the adjacent pair of the input surface portions 221. It should be also noted that the number of the input surface portions 221 is net limited by the embodiment. For example, for the light input surface 22 of each of the light guide plates 2, there may he only one input surface portion 221 formed with one recess 223 without the presence of any connecting surface portions 222.

Moreover, the light output surface 23 of each of the light guide plates 2 is formed with a plurality of light guide teeth 231 that are arranged in the longitudinal direction 25.

A distance between the side surfaces 21 of each of the light guide plates 2 (i.e., the thickness of each of the light guide plates 2) is not greater than 10 millimeters, and all light guide plates 2 have the same shape and size. For each adjacent pair of the light guide plates 2, one of the side surfaces 21 of one of the light guide plates 2 faces one of the side surfaces 21 of the other one of the light guide plates 2, such that the light input surfaces 22 of the light guide plates 2 are adjacent to each other with the input surface portions 221 of the light input surface 22 of the one of the light guide plates 2 being aligned respectively with the input surface portions 221 of the light input surface 22 of the other one of the light guide plates 2 in the thickness direction 24. In this embodiment, for each adjacent pair of the light guide plates 2, the one of the side surfaces 21 of the one of the light guide plates 2 clings to the one of the side surfaces 21 of the other one of the light guide plates 2. However, not limited by the embodiment, the light guide plates 2 may also not cling to each other, or possess different shapes and sizes.

In this embodiment, the light emitting modules 3 are arranged in the longitudinal direction 25 and are disposed at positions that correspond respectively to the registered ones of the input surface portions 221 of the light input surfaces 22 of the light guide plates 2. As shown in FIG. 2 and FIG. 4, each of the light emitting modules 3 includes a circuit board 31 that faces the light input surfaces 22 of the light guide plates 2 and that has a length in the thickness direction 24 not smaller than a total thickness of the light guide plates 2 in the thickness direction 24, a plurality of light emitting members 32 that are mounted on the circuit board 31 at positions corresponding respectively to the light input surfaces 22 of the light guide plates 2, a light converging member 33 disposed between the light emitting members 32 and the light input surfaces 22 of the light guide plates 2, and a heat sink 34 that is connected to the circuit board 31. It should also be noted that number of the light emitting modules 3 is not limited by the embodiment, and may vary according to practical demands.

In this embodiment, a length of the circuit board 31 of each light emitting module 3 in the thickness direction 24 is not smaller than a total length of a respective aligned group of the recesses 223 of the input surface portions 221 of the light input surfaces 22 of the light guide plates 2. For each of the light emitting modules 3, a single circuit board 31 is used for being mounted with the light emitting members 32 instead of multiple circuit boards 31, thereby resulting in a relatively low assembling cost. However, the circuit boards 31 of, for example, two of the light emitting modules 3 may be formed as one piece and mounted with the light emitting members 32 of the two of the light emitting modules 3 so that the number of elements on each of the light emitting modules 3 can be reduced. In this embodiment, each of the light emitting members 32 is configured as a light emitting diode.

For each of the light emitting modules 3, the light converging member 33 is made of transparent plastic materials, and has a plurality of converging portions 331. Each of said converging portions 331 is received in the recess 223 of the light input surface 22 of the light guide plates 2, and has an input face 332 that is concave and that faces a respective one of the light emitting members 23, and an output face 333 that is convex, that faces a respective one of the input surface portions 221 of the light input surfaces 22 of the light guide plates 2, and that is formed with two face ridges 334.

For each of the light emitting modules 3, the heat sink 34 is made of a metal with good thermal dissipation properties, and has a base board 341 that is connected to the circuit board 31 and that is disposed opposite to the light emitting members 32, and a plurality of fins 342 that extend from the base board 341 away from the light emitting members 32. It should also be noted that the arrangement of the heat sink 34 is not limited by the embodiment, and may vary in a similar manner as the circuit board 31.

As shown in FIG. 1, the housing 1 has a base wall 11, and a surround wall 12 that extends from a periphery of the base wall 11 to define a containing space 10 for receiving the light guide plates 2 and the light emitting modules 3.

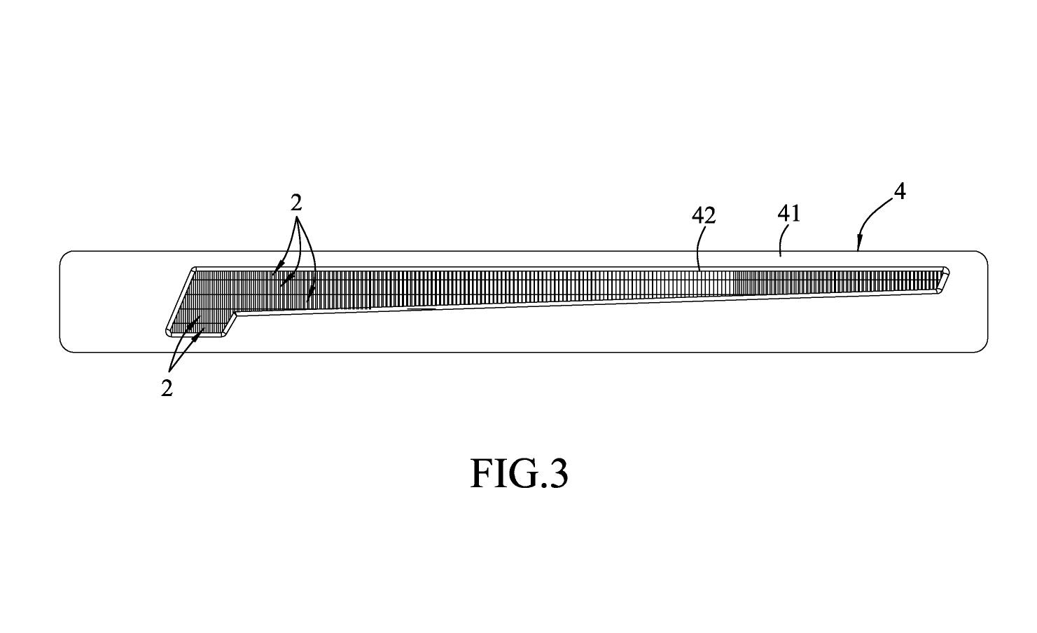

As further shown in FIG. 3, the cover member 4 has a block portion 41 covering a portion of the light output surfaces 23 of the light guide plates 2, and a transparent portion 42 for permitting passage of light emitted from the light emitting modules 3 therethrough. In this embodiment, the transparent portion 42 is a through hole. It should be noted that, the number and shape of the transparent portion 42 may vary in other embodiments. In addition, the transparent portion 42 may also be configured as a combination of a through hole and a transparent cover disposed at the through hole.

In use, for each of the light emitting modules 3, light emitted from the light emitting members 32 enters the light converging member 33 via the input face 332 and is converged for enhancing the brightness of the light emitting members 32. Afterward, the light exits the light converging member 33 via the output face 333 and enters the light guide plates 2 via the light input surfaces 22. The light in each of the light guide plates 2 is reflected between the side surfaces 21 and finally exits via the light output surface 23. Moreover, the light guide teeth 231 and the face ridges 334 can aid to refract and evenly distribute the light during the above-mentioned light transmission.

The light emitting members 32 of each of the light emitting modules 3 may be configured to generate lights of different colors, with the light emitting members 32 corresponding to the same one of the light guide plates 2 generating light of the same color. As such, each of the light guide plates 2 can deliver a specific visual function. For example, the light guide plate 2 that generates white light can serve as a head lamp including such functions as delivering a day-time running signal and emitting a high beam or low beam, the light guide plate 2 that generates yellow light can serve as a direction light, and the light guide plate 2 that generates red light can serve as a tail lamp to deliver a stop signal.

To sum up, one may easily design light projections of different sizes and shapes by connecting together a desired number of the light guide plates 2. Also, with different color configurations of the light emitting members 32, each of the light guide plates 2 may function as a different type of lamp. Therefore, the cost of building a new mold for shaping a new light guide lens of the vehicle lamp, and the time required to form and process a thick plate-shaped light guide lens can be saved.

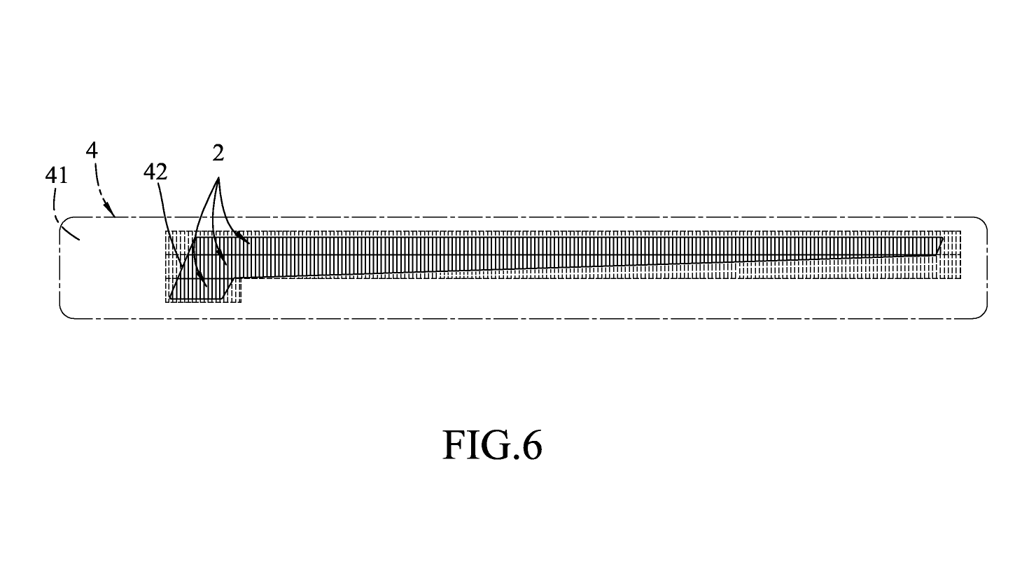

Referring to FIG. 6, a second embodiment of the vehicle lamp according to the disclosure is illustrated. The second embodiment has a structure similar to that of the first embodiment, but is different in that the number of the light guide plates 2 is three, and that one of the light guide plates 2 is shortened so as to properly fit the shape of the transparent portion 42 of the cover member 4.

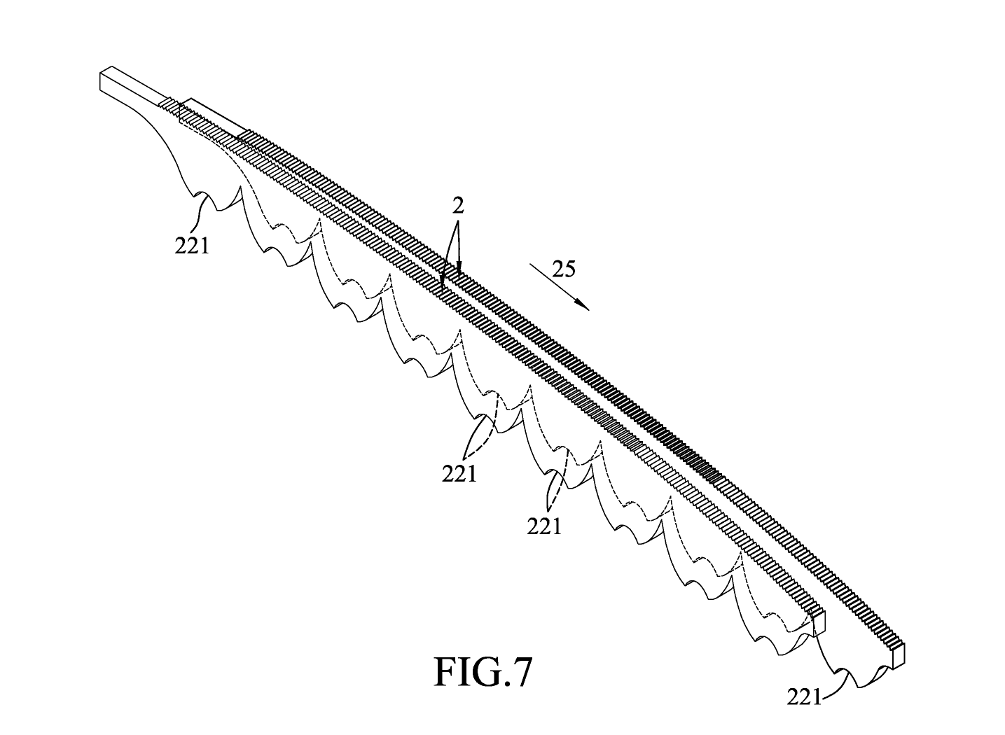

Referring to FIG. 7, the third embodiment of the vehicle lamp according to the disclosure is illustrated. The third embodiment also has a structure similar to that of the first embodiment, but is different in the arrangement of the light guide plates 2 and the light emitting modules 3. In the third embodiment, the number of the light guide plates 2 is two, and one of the light guide plates 2 is shifted aside from the other in the longitudinal direction 25. Specifically, an endmost one of the input surface portions 221 of the light input surface 22 of one of the light guide plates 2 is positioned alone without being aligned with any one of the input surface portions 221 of the other one of the light guide plates 2. Likewise, an opposite endmost one of the input surface portions 221 of the light input surface 22 of the other one of the light guide plates 2 is positioned to be alone. The remainder of the input surface portions 221 of the one of the light guide plates 2 are respectively aligned with the input surface portions 221 of the other one of the light guide plates 2.

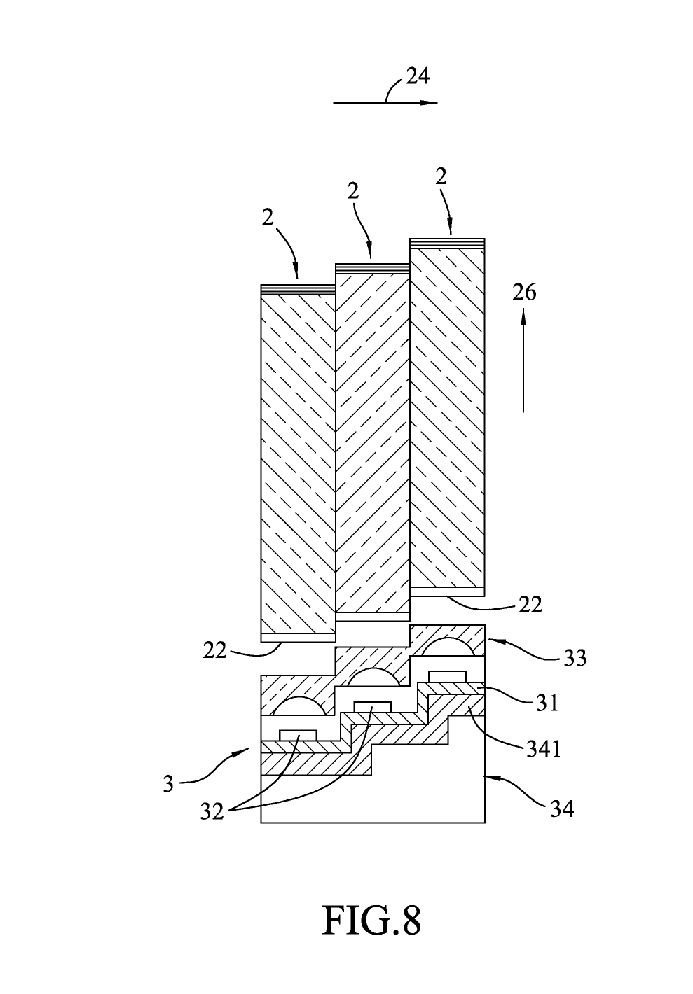

Referring to FIG. 8, the fourth embodiment of the vehicle lamp according to the disclosure is illustrated. The fourth embodiment also has a structure similar to that of the first embodiment, but is different in the arrangement of the light guide plates 2 and the design of the light emitting modules 3. In the fourth embodiment, the number of the light guide plates 2 is three, and the light guide plates 2 are shifted aside of one another in a transverse direction 26 transverse to the thickness direction 24 and the longitudinal direction 25. Accordingly, the circuit board 31, the light converging member 33 and the heat sink 34 of each of the light emitting modules 3 are all formed to have a stepped shape so as to fit the shifted light guide plates 2.

While the present disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A vehicle lamp comprising:
two light guide plates, each of which has two side surfaces that are opposite to each other in a thickness direction, and a light input surface and a light output surface that interconnect said side surfaces, a length in the thickness direction between said side surfaces being not greater than 10 millimeters, one of said side surfaces of one of said light guide plates facing one of said side surfaces of the other one of said light guide plates such that said light input surfaces of said light guide plates are adjacent to each other; and
at least one light emitting module including
a circuit board that faces said light input surfaces of said light guide plates, and that has a length in the thickness direction not smaller than a total length of said light guide plates in the thickness direction,
a plurality of light emitting members that are mounted on said circuit board, each of said light emitting members being disposed at a position that corresponds to said light input surface of a corresponding one of said light guide plates, and
a heat sink that is connected to said circuit board.

2. The vehicle lamp as claimed in claim 1, further comprising:
a housing that retains said light guide plates and said at least one light emitting module therein; and
a cover member that is coupled to said housing, and that has a block portion covering a portion of said light output surfaces of said light guide plates, and a transparent portion for permitting passage of light emitted from said at least one light emitting module there through.

3. The vehicle lamp as claimed in claim 1, wherein the lengths of said light guide plates in the thickness direction are the same.

4. The vehicle lamp as claimed in claim 1, wherein the one of said side surfaces of the one of said light guide plates clings to the one of said side surfaces of the other one of said light guide plates.

5. The vehicle lamp as claimed in claim 2, wherein the one of said side surfaces of the one of said light guide plates clings to the one of said side surfaces of the other one of said light guide plates.

6. The vehicle lamp as claimed in claim 3, wherein the one of said side surfaces of the one of said light guide plates clings to the one of said side surfaces of the other one of said light guide plates.

7. The vehicle lamp as clamed in claim 1, wherein said light emitting members emit lights of different colors.

8. The vehicle lamp as claimed in claim 1, wherein said light input surface and said light output surface of each of said light guide plates are spaced apart from each other.

9. The vehicle lamp as claimed in claim 8, wherein:
said light input surface of each of said light guide plates has an input surface portion formed with a recess; and
said at least one light emitting module further includes a light converging member that has a plurality of converging portions, each of said converging portions being received in said recess of said input surface portion of said light input surface of a respective one of said light guide plates, and having an input face that faces a respective one of said light emitting members, and an output face that faces said input surface portion of said light input surface of the respective one of said light guide plates.

10. The vehicle lamp as claimed in claim 8, wherein:
said light input surface of each of said light guide plates has a plurality of input surface portions arranged in a longitudinal direction that is transverse to the thickness direction; and
said vehicle lamp comprises a plurality of said light emitting modules arranged in the longitudinal direction and. disposed at positions that correspond to a corresponding one of said input surface portions of said light guide plates.

11. The vehicle lamp as claimed in claim 10, wherein:
each of said input surface portions of said light input surfaces of said light guide plates is formed with a recess;
each of said light emitting modules further includes a light converging member that has a plurality of converging portions, each of said converging portions being received in said recess of a corresponding one of said input surface portions of said light input surfaces of said light guide plates, and having an input face that faces a corresponding one of said light emitting members of said light emitting modules, and an output face that faces the corresponding one of said input surface portions of said light input surfaces of said light guide plates.

12. The vehicle lamp as claimed in claim 1, wherein:
said light input surface of each of said light guide plates has a plurality of input surface portions, said input surface portions of one of said light guide plates being aligned respectively with said input surface portions of the other one of said light guide plates;
said vehicle lamp comprises a plurality of said light emitting modules, the length of said circuit board of each of said light emitting modules in the thickness direction being not smaller than a total length of a respective aligned pair of said input surface portions of said light input surfaces of said light guide plates in the thickness direction.
